(19) United States
(12) Patent Application Publication
(10) Pub. No.: US 2026/0088194 A1
(43) Pub. Date: Mar. 26, 2026

(54) MAGNETIC DATA CABLE

(71) Applicant: Shenzhen Enshan Green Energy Technology Co., Ltd, Shenzhen (CN)

(72) Inventor: Shanping ZHEN, Shenzhen (CN)

(21) Appl. No.: 18/966,168

(22) Filed: Dec. 3, 2024

(30) Foreign Application Priority Data
Sep. 26, 2024 (CN) 2024223644430

(51) Int. Cl. H01B 7/08; H01B 7/04

(52) U.S. Cl. CPC H01B 7/0823; H01B 7/04

(57) ABSTRACT

The utility model relates to the technical field of digital products, in particular to a magnetic data cable, which comprises a wire which is filled with a magnetic material layer and can be wound for storage, connection heads used for external electrical connection are arranged at both ends of the wire, the wire is composed of a bending part, coil parts and connection heads in the winding and storage state, at least two coil parts are arranged in concentric circles, the surface contact type magnetic connection is adopted between two adjacent coil parts, the connection heads at both ends are located at the outermost layer of the coil parts and form a free end that is easy to pull. The magnetic data cable is easily stored and carried, and is not easily deformed.

### TECHNICAL FIELD

The utility model relates to the technical field of digital products, in particular to a magnetic data cable.

### BACKGROUND ART

Data cable is a cable that transmits data and power between electronic devices, and can meet different requirements according to different interfaces and transmission protocols.

Traditional data cable is not easily stored and is easily intertwined, and the unwinding process is time-consuming and laborious; in addition, too long data cable occupies a lot of space when not needed, and is not easily carried.

In the prior art, the patent CN202310377554.2 provides a magnetic data cable, which comprises a cable body and a data connector connected to the end of the cable body, the cable body comprises a wire core and wrapping material layers wrapped outside the wire core, at least one layer of the wrapping material layers is a magnetic material layer, and the data cable is arranged spirally by stacking upper and lower layers, and the magnetic material layers are used between the adjacent data cables for mutual magnetic absorption. However, the stacked spiral arrangement of the data cable makes the data cable height increased, and the data cable is easily compressed when placed in the storage bag, resulting in the deformation of the data cable; the performance and life of the data cable will be affected if the data cable is in this state for a long time.

### SUMMARY OF THE UTILITY MODEL

To solve the problems in the background art, the utility model provides a magnetic data cable, which occupies a small space and has low height in the storage state, is easily stored and carried and is not easily deformed, and connection heads are easily pulled.

The scheme adopted by the utility model adopts the following technical proposal to solve the technical problem: A magnetic data cable comprises a wire which is filled with a magnetic material layer and can be wound for storage, connection heads used for external electrical connection are arranged at both ends of the wire, the wire is composed of a bending part, coil parts and connection heads in the winding and storage state, at least two coil parts are arranged in concentric circles, the surface contact type magnetic connection is adopted between two adjacent coil parts, the connection heads at both ends are located at the outermost layer of the coil parts and form a free end that is easy to pull.

Further, the bending part is made of non-magnetic material or magnetic material.

When the bending part of the application is made of magnetic material, the magnetic pole of the opposite surface is opposite when the bending part is folded in half.

Further, the bending part is folded in half when the wire is in the winding and storage state, and both ends of the bending part and the adjacent coil parts thereof are formed in one body.

Further, the wire comprises a wire core, a magnetic layer and an outer insulating layer arranged in sequence from the inside to the outside.

Further, the coil part is arranged in a flat shape along the cross section vertical to the length direction of the wire when the wire is naturally extended.

Further, the connection heads at both ends point in different directions respectively when the wire is in the winding and storage state.

To sum up, the utility model has the following beneficial effects:
When the magnetic data cable is in the storage state, the coil parts are arranged in concentric circles at low height, so that the magnetic data cable is easily stored and not easily deformed;
When the wire is in the winding and storage state, the connection heads at both ends are located in the outermost layer of the coil part, which is convenient for the user to pull and use; at the same time, the user can choose the pulling length according to the need and does not need to pull the whole cable, so that the magnetic data cable of the application can maintain a regular state during storage and use;
The bending part is made of non-magnetic material or magnetic material, which is easy for the user to fold in half, and can also reduce the volume of the magnetic data cable in the storage state;
the coil part is arranged in a flat shape along the cross section vertical to the length direction of the wire when the wire is naturally extended, which is convenient for the user to store the data cable, and ensures the structure of the data cable is more stable in the storage state;
The connection heads at both ends point in different directions respectively when the wire is in the winding and storage state, which is easy for the user to pull the connection head in different directions.

The above description is only an overview of the technical proposal of the utility model. To better understand the technical means of the utility model, the contents of the specification can be followed. Moreover, to more clearly understand the above purposes and other purposes, features and advantages of the utility model, the preferred embodiments are described in detail below in combination with the drawings.

### BRIEF DESCRIPTION OF THE DRAWINGS

FIG. 1 is the structural diagram for the magnetic data cable of the embodiment during storage.

FIG. 2 is the section view for the connection head of the embodiment.

FIG. 3 is the schematic diagram for the wire shown in FIG. 1.

FIG. 4 is the state diagram when the first coil and the second coil are folded in half.

FIG. 5 is the structural diagram for the magnetic data cable of the embodiment during use.

In the drawings: 100. Magnetic data cable; 101a. First winding port; 101b. Second winding port; 10. Wire; 11. First coil; 11a. First face; 12. Second coil; 12a. Second face; 13. Bending part; 101. Wire core; 102. Magnetic layer; 103. Insulation layer; 20. First connection head; 30. Second connection head.

### DETAILED DESCRIPTION OF THE UTILITY MODEL

In order to clearly understand the content of the utility model, the utility model is further described according to the embodiments and the drawings.

It should be noted that the orientation or position relationships indicated by the terms such as “center”, “upper”, “lower”, “front”, “rear”, “left”, “right”, “inner” and “outer” used herein are based on the orientation or position relationships shown in the drawings, which are only intended to easily describe the utility model and simplify the description, not intended to indicate or imply that the device or element referred to must have a specific orientation, be constructed and operated in a specific orientation. Therefore, they cannot be understood as limitations to the utility model. Unless otherwise stated, “a plurality of”means two or more.

Unless otherwise expressly specified and limited, the terms “installed”, “connected together” and “connected” shall be understood in a broad sense, for example, it may be fixedly connected, detachably connected or integrally connected; it may be mechanically connected or electrically connected; it may be directly connected or connected through an intermediate medium or connected within two components. Ordinary technicians in the field may understand the specific meanings of the above terms in the utility model as the case may be.

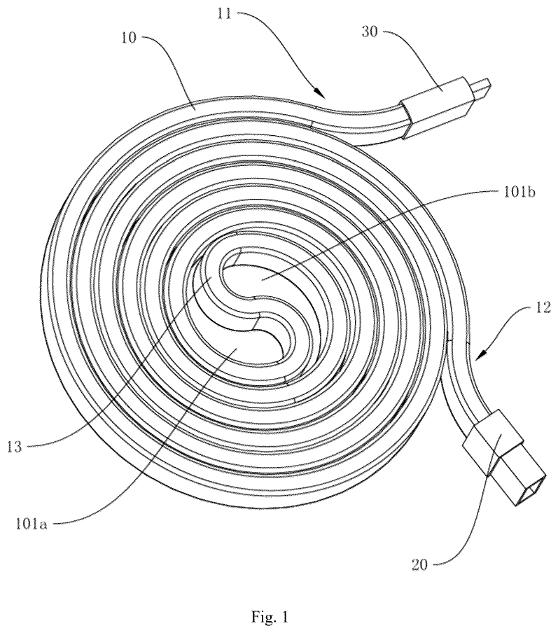

As shown in FIG. 1 to FIG. 5, a magnetic data cable 100 comprises a wire 10 which is filled with a magnetic material layer and can be wound for storage, and a first connection head 20 and a second connection head 30 are respectively arranged at two ends of the wire 10.

As shown in FIG. 1, the wire 10 is composed of a bending part 13, coil parts and connection heads in the winding and storage state, a plurality of coil parts are arranged in concentric circles, the surface contact type magnetic connection is adopted between two adjacent coil parts, the connection heads at both ends are located at the outermost layer of the coil parts and form a free end that is easy to pull.

Wherein, the bending part 13 is folded in half when the wire 10 is in the winding and storage state, and the coil part comprises at least a first coil 11 and a second coil 12 extending from both ends of the bending part 13 and wound together along the outside of the bending part 13; it should be noted that both ends of the bending part 13 and the adjacent coil parts thereof are formed in one body.

As shown in FIG. 1, the first connection head 20 is arranged at the end of the first coil 11, the second connection head 30 is arranged at the end of the second coil 12, the first connection head 20 and the second connection head 30 are respectively located at the outermost layer of the coil when the first coil 11 and the second coil 12 are wound together along the outside of the bending part 13, wherein the first connection head 20 is a USB interface, and the second connection head 30 is a Type-C connector.

Through the above proposal, the first connection head 20 and the second connection head 30 can be respectively separated from the two outermost circles and connected to the corresponding electronic devices when the magnetic data cable 100 is in use. Moreover, because the wire 10 is filled with magnetic material, the wound inner circle can still be adsorbed on the iron shell near the electronic device when the first connection head 20 and the second connection head 30 on the outer circles are separated, thereby avoiding the problem that one connecting end of the existing magnetic data cable 100 is wound to the inside of the coil to cause the wire 10 to be disordered during pulling, avoiding the problem of difficult adsorption resulting from the wire 10 wrapped into a stacked coil part and forming a three-dimensional shape, and solving the disorder problem of the wire 10.

At the same time, the coil parts are arranged in concentric circles at low height, so that the magnetic data cable is easily stored and not easily deformed; the connection heads at both ends are located in the outermost layer of the coil part, which is convenient for the user to pull and use. In addition, the user can choose the pulling length according to the need and does not need to pull the whole cable, so that the magnetic data cable 100 of the application can maintain a regular state during storage and use.

It should be noted that the magnetic data cable 100 in the application can be used for the connection of two electrical devices such as a mobile phone and a computer, and can also be used for the connection of other electrical devices such as a television and a set-top box. In the above proposal, the first connection head 20 and the second connection head 30 are pulled out and respectively inserted into the television and the set-top box, the winding part of the coil can be directly attached to the partial position of the television and the set-top box because of the magnetic and flat structure above and below, the operation is simple, small space is occupied, and the wire harness is easily placed and not disordered due to pulling out from the inner circle.

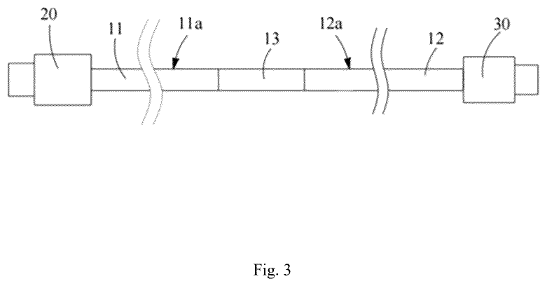

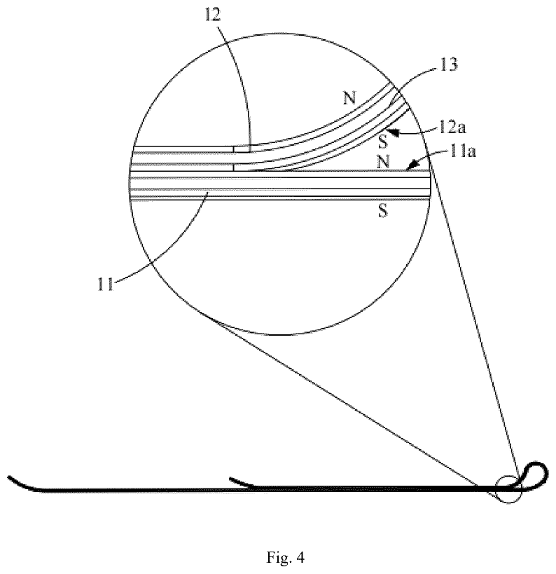

The first coil 11 and the second coil 12 of the embodiment are jointly wound by means of superposition. To prevent the first connection head 20 or the second connection head 30 from being wound into the inside of the coil part, the superposed first coil 11 and second coil 12 are integrally positioned, and the wire 10 is magnetized through a magnetizing machine, and two different magnetic poles, namely a first face 11a and a second face 12a, are formed at the part where the first coil 11 and the second coil 12 are fitted because two different magnetic poles are formed at both ends of the magnetizing machine. As shown in FIG. 3 and FIG. 4, when two faces (namely the first face 11a and the second face 12a) fitted mutually and having opposite polarity are turned over and straightened, the first face 11a and the second face 12a are in the same plane and have opposite polarity.

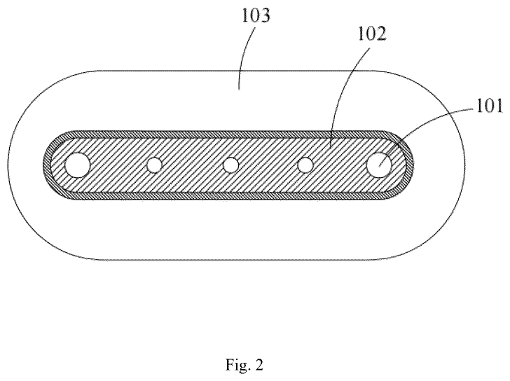

As shown in FIG. 2, the wire 10 of the embodiment comprises a wire core 101, a magnetic layer 102 and an outer insulating layer arranged in sequence from the inside to the outside. In addition, a shielding layer capable of preventing electromagnetic interference and signal interference can be arranged outside the insulation layer 103 and can be made of copper foil or aluminum foil.

The magnetization process of the magnetic data cable 100 in the embodiment is as follows: First, provide at least two or more metal wires, usually copper wires or copper alloy wires. Then, wrap the outer surface of each metal wire with an insulation layer 103 to avoid short circuit or signal interference in the subsequent process. Fix one end of the metal wire onto a first organizer and wind the metal wire on the organizer, fix the other end thereof onto a second organizer, straighten the metal wires for positioning, and ensure that the metal wires are flat and not staggered during operation. To control the shape and size of a rubber layer, first place the metal wire in a mold, which is used to define the cross-section shape of the rubber layer, and inject liquid rubber mixed by rubber and magnetic powder into the mold through a rubber coating machine. The heated liquid rubber presents fluidity and can be evenly coated around the metal wires. After being injected into the mold, the liquid rubber is required to be cooled to solidify and form a rubber layer. In the process, the rubber layer is wrapped around the outside of the metal wires and filled between the metal wires. Before magnetization treatment, position the metal wires coated with rubber again to ensure the stability of the wire 10 during the magnetization process, and magnetize the rubber layer by a magnetizer. Place the metal wires coated with the rubber layer into the magnetizer, and start the magnetization procedure. The magnetizer magnetizes both sides of the rubber layer into different polarities, one side is S pole and the other side is N pole. Then, place the magnetized metal wires and rubber layer into an oven, set the baking temperature to 80 to 110 degrees C. and the time to 25 to 35 minutes, bake the magnetized rubber layer within the set temperature and time to cure and set the rubber layer. A protective layer is formed on the outer surface of the rubber layer, braided wires are usually used for covering, the thickness of the protective layer is controlled at no more than 0.6 mm, and the protective layer is evenly covered outside the rubber layer by special equipment to ensure that the protective layer can provide additional mechanical and electromagnetic protection for the rubber layer. Cut the metal wires coated with the magnetic rubber layer to the desired length by a cutting machine. The step can be performed after the magnetization process or other steps. Then, prepare and weld the first connection head 20 and the second connection head 30 onto the ends of the metal wires respectively. Note to remove the rubber layer at the ends of the metal wires by a wire stripping machine before welding and expose the metal wire part for welding. Use a fixture with a spiral barrier structure in the winding operation, and a groove structure is arranged on the periphery of the fixture for placing the metal wires and the magnetic rubber layer; place the metal wires and the magnetic rubber layer in the groove structure in turn, wind the metal wires and the magnetic rubber layer in sequence to form a plurality of magnetic coils. Ensure that the adjacent magnetic coils are arranged in sequence and the structure is compact. Finally, put the fixture and the magnetic cable into the oven again after the winding is completed, set the corresponding baking temperature and time, bake the wound magnetic cable for a second time within the preset temperature and time to ensure the setting and stability of the magnetic layer.

Understandably, in the above embodiments, an adhesive layer is mixed with magnetic powder, and the magnetic material layer is formed in the wire 10 by baking, curing, cutting, joint welding, winding and re-baking. However, the way to form the magnetic material layer is not limited to this. For example, in another embodiment, the magnetic material layer can be formed by burying a magnetic strip directly or filling with magnetic powder.

The bending part 13 of the embodiment is made of non-magnetic material or magnetic material.

When the bending part 13 is made of magnetic material, the magnetic pole of the opposite surface to the bending part 13 is opposite in the folding state, the bending part is more easily folded by magnetic attraction, and the first coil 11 and the second coil 12 are easily superimposed. Through the above proposal, the user can easily fix the coils together by magnetic attraction when storing the data cable, thereby reducing the disorder of the wire 10 and improving the storage efficiency.

When the bending part 13 is made of non-magnetic material, the bending part 13 can prevent repulsion between the first coil 11 and the second coil 12; the non-magnetic material can maintain shape and performance and reduce damage caused by wear or fatigue during the frequent use and folding of the data cable. The bending part 13 made of non-magnetic material facilitates the user to fold and can also reduce the volume of the magnetic data cable 100 in the storage state.

It should be noted that the design of the bending part 13 made of magnetic or non-magnetic material takes into account the volume reduction of the magnetic data cable 100 in the storage state, so that the coil is compact during storage, thereby reducing space occupation and improving portability. The users who often need to carry data cables can manage and store the data cable more easily.

As shown in FIG. 3, when the wire 10 of the embodiment is naturally extended, the coil part is arranged in a flat shape along the cross section vertical to the length direction of the wire 10. The above arrangement can increase the contact area of each coil in the coil part, so that the wire 10 is not easily distorted or deformed when rolled or folded, thereby ensuring the service life and performance of the wire 10, facilitating the user to store the data cable and making the structure of the data cable more stable in the storage state.

As shown in FIG. 4 and FIG. 6, the length of the first coil 11 on the wire 10 is different from that of the second coil 12, and the first coil 11 is longer than the second coil 12, so that the connection heads at both ends point in different directions respectively when the wire 10 is in the winding and storage state, and the user can pull the connection head in different directions to avoid the problem that the second coil 12 is difficultly pulled out when the first coil 11 is shorter than the second coil 12.

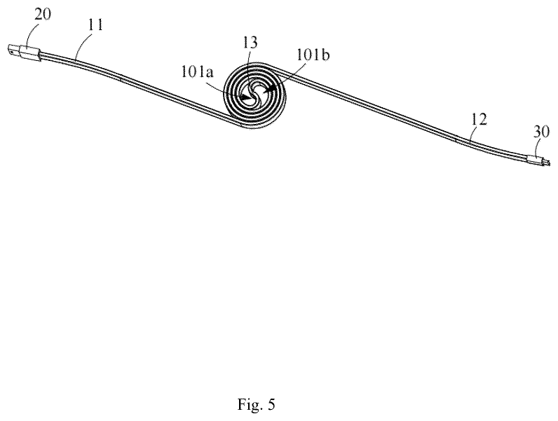

As shown in FIG. 5, to easily wind the wire 10, the bending part 13 is wound to form a first winding port 101a and a second winding port 101b arranged at the axis of the coil part, and the first winding port 101a and the second winding port 101b are used for human fingers or mechanical equipment to pass through. It should be noted that the wire 10 is generally driven by the shaft rotation driven by the hand or the motor in the winding process of the wire 10. In the application, the first winding port 101a and the second winding port 101b are arranged to facilitate the hand or machine shaft to reach for winding the wire 10.

The above embodiments are only the preferred embodiments of the utility model, and cannot be used to limit the scope of protection of the utility model. Any non-substantive changes and modifications made by the technicians in the field on the basis of the utility model fall within the scope of protection of the utility model.

1. A magnetic data cable, comprising a wire which is filled with a magnetic material layer and can be wound for storage, connection heads used for external electrical connection are arranged at both ends of the wire, and characterized in that the wire is composed of a bending part, coil parts and connection heads in the winding and storage state, at least two coil parts are arranged in concentric circles, the surface contact type magnetic connection is adopted between two adjacent coil parts, the connection heads at both ends are located at the outermost layer of the coil parts and form a free end that is easy to pull.

2. The magnetic data cable according to claim 1, characterized in that the bending part is made of non-magnetic material or magnetic material.

3. The magnetic data cable according to claim 2, characterized in that the bending part is folded in half when the wire is in the winding and storage state, and both ends of the bending part and the adjacent coil parts thereof are formed in one body.

4. The magnetic data cable according to claims 1, characterized in that the wire comprises a wire core, a magnetic layer and an outer insulating layer arranged in sequence from the inside to the outside.

5. The magnetic data cable according to claim 1, characterized in that the coil part is arranged in a flat shape along the cross section vertical to the length direction of the wire when the wire is naturally extended.

6. The magnetic data cable according to claim 1, characterized in that the connection heads at both ends point in different directions respectively when the wire is in the winding and storage state.
